(19) United States
(12) Patent Application Publication
(10) Pub. No.: US 2002/0151287 A1
(43) Pub. Date: Oct. 17, 2002

(54) Receiver front-end filter tuning

(76) Inventors: Bjorn Lindquist, Bjarred (SE); Martin Isberg, Lund (SE)

Correspondence Address: Ronald L. Grudziecki, BURNS, DOANE, SWECKER & MATHIS, L.L.p., P.O. Box 1404, Alexandria, VA, 22313-1404, US

(21) Appl. No.: 09/836,523

(22) Filed: Apr. 17, 2001

(51) Int. Cl. H04B 1/18

(52) U.S. Cl. 455/183.1; 455/266; 455/256; 455/307; 455/192.1

(57) ABSTRACT

A radio receiver has a front-end circuit that generates a radio frequency (RF) signal. The front-end circuit includes a first tunable band-pass filter that is capable of tunably selecting channels within at least one frequency band. To tune the first tunable band-pass filter, the receiver further includes a local oscillator circuit for generating a local oscillating signal, and a second tunable filter coupled to receive a signal derived from the local oscillating signal and to generate therefrom a filtered local oscillating signal. A control unit in the receiver is coupled to receive a signal derived from the filtered local oscillating signal. The control unit generates a control signal based on the signal derived from the filtered local oscillating signal. The control signal is supplied to the first tunable band-pass filter and to the second tunable filter for tuning the first tunable band-pass filter and the second tunable filter.

### BACKGROUND

The present invention relates to front-end filters for a receiver, and particularly to techniques and apparatuses for tuning receiver front-end filters.

Radio receivers are designed to receive modulated signals (e.g., amplitude modulated (AM), frequency modulated (FM), and 8-symbol phase shift keying (8-PSK) signals) centered at particular carrier frequencies. In typical broadcast systems, a broad band of carrier frequencies is typically divided up into a number of adjacent channels, each centered at a unique carrier frequency and having its own associated narrow bandwidth. The adjacent channels are designed not to overlap one another, in order to avoid interference between neighboring channels.

When a radio receiver is tuned to a particular one of these channels, it needs to be selectively responsive to the radio signals within the narrow bandwidth centered at the channel's center frequency. At the same time, the radio receiver needs to be capable of rejecting (i.e., being substantially non-responsive to) signals falling outside of its narrow frequency band.

Although the radio receiver is tuned to receive a channel at a particular carrier frequency, this high frequency signal (referred to as “radio frequency”, or RF) is typically converted to a lower frequency, or “baseband”, signal before the information modulated onto the signal is extracted and processed. This frequency conversion is typically performed by means of mixers, which mix the received RF signal with another signal. The RF signal (having a given carrier frequency) may be converted directly to the baseband signal by mixing the received RF signal with a signal oscillating at the same carrier frequency. Receivers that operate in this fashion are called “homodyne” receivers.

It is often desirable to convert the RF signal down to the baseband signal in incremental steps, rather than in one step. In such cases, the RF signal may first be converted into one or more so-called “intermediate frequency” (IF) signals, which are centered at respective frequencies lying somewhere in-between those of the RF signal and the baseband signal. Receivers that operate in this fashion are called “heterodyne” receivers.

Generation of an IF signal may be accomplished by mixing the original RF signal with a locally generated signal oscillating at a different carrier frequency. The resultant IF signal will carry the desired information on an oscillating signal whose center frequency is related to the difference between the RF carrier frequency and the locally generated signal. Because it is usually desired to generate an IF signal whose frequency is fixed, regardless of the carrier frequency of the received RF signal, receivers are designed such that the difference between the received RF carrier frequency and the frequency of the locally-generated signal will be maintained at a constant value. For example, as the front-end of the receiver is adjusted to receive a higher/lower RF carrier signal, the generator of the locally-generated signal is correspondingly adjusted to generate a higher/lower frequency signal, such that the difference between the two frequencies does not change.

Regardless of the type, a receiver needs to be capable of withstanding the presence of strong interfering signals within the same frequency band as the desired received signal. However, in many radio environments such as that found in mobile telecommunications, there can exist interfering signals that are only a few megahertz (MHZ) away from the desired signal. Furthermore, these interfering signals can sometimes be several orders of magnitude stronger than the desired signal.

To mitigate the effects of such strong nearby interfering signals, while simultaneously achieving as good a dynamic range as possible, a receiver is often a compromise between design choices favoring small signal properties (e.g., low noise characteristics) and other design choices favoring large signal properties (e.g., intercept point and signal compression). To illustrate this point, several conventional receivers will be described.

FIG. 1 is a block diagram of a conventional single band homodyne receiver. An RF signal is received by an antenna 101 and supplied to a band-pass filter 103 that suppresses all out-of-band interferers so that they will not exceed the level of the in-band interferers. This is done in order to prevent blocking of the receiver. In the exemplary embodiment, the desired frequency band is the range from 1805 to 1880 MHZ. The band-pass filter thus acts as a band selection filter, also known as a pre-selection filter or blocking filter.

From the output of the band-pass filter 103, the received signal is supplied to a low noise amplifier 105. After amplification, the signal is down-converted to respective in-phase (I) and quadrature (Q) baseband signals by first and second mixers 107, 109. This is accomplished by mixing the amplified received signal with respective locally-generated signals that each oscillate at the desired RF frequency, but which are 90 degrees out of phase with respect to one another. The purpose of separating the received signal into the I and Q baseband signals is to facilitate the demodulation of the signal (i.e., the extraction of the underlying information carried by the received signal). This aspect of the receiver operation is well-known, and need not be discussed here in further detail.

The respective locally-generated signals for use by the first and second mixers 107, 109 are created by first using a local oscillator circuit 125 to generate a signal of the desired frequency. The local oscillator circuit 125 is often implemented as a phase-locked loop (PLL). The signal from the local oscillator circuit 125 is then supplied to a phase-shifting circuit 111 that shifts the phase of the locally-generated signal by 90 degrees. The original (non-shifted) signal may then be supplied to the first mixer 107, while the phase-shifted signal may be supplied to the second mixer 109.

After down-conversion, the I and Q baseband signals are supplied to respective first and second channel selection filters 113, 115. The pass-band of each of these channel selection filters 113, 115 is much narrower than that of the band selection filter 103 because it is used to separate the received signal from the in-band interferers. After channel selection, the resultant I and Q signals could be subjected to further filtering and amplification (e.g., by respective first and second amplifiers 117, 119. In digital environments, the resultant analog signals may be converted into digital form by respective first and second analog-to-digital (A/D) converters 121, 123.

At this point it should be noted that, in the case of a heterodyne receiver, an extra mixing stage (not shown) would be disposed between the output of the low noise amplifier 105 and the inputs of the first and second mixers 107, 109. The extra mixing stage would generate an IF signal by mixing the originally received RF signal with a locally-generated signal that oscillates a frequency that differs from the carrier frequency of the RF signal by a known amount. A channel selection filter may then operate on the IF signal, and its output supplied to the first and second mixers 107, 109 for a second down-conversion to the baseband frequency. In this case, the frequency of the locally-generated signals respectively supplied to the first and second mixers 107, 109 would be designed to match the frequency of the IF signal, rather than the frequency of the RF signal.

The active parts of the receiver, such as the low noise amplifier 105 and mixers 107, 109, are designed to exhibit good noise properties while also being able to withstand strong signals without degrading performance for weak signals. Consequently, the design will always be a trade-off between considerations relating to noise, linearity, and power consumption.

In many applications, it is desirable to have a radio receiver that is capable of operating in any of a number of distinct frequency bands. For example, a cellular telephone may be designed to operate in accordance with any of a number of different standards, each operating within a distinct frequency band. FIG. 2 is a block diagram of a conventional dual-band homodyne receiver that is capable of receiving signals in either of two frequency bands: a first band ranging from 1805 to 1880 MHZ, and a second band ranging from 1930 to 1990 MHZ. In order to enable the reception of two distinct frequency bands, the front-end of the receiver includes two distinct paths. In a first path, a first band-pass filter 201 is designed to suppress frequencies outside the range from 1805 to 1880 MHZ. The resultant signal is supplied to a first low noise amplifier 203. Similarly, in a second path of the front-end of the receiver, a second band-pass filter 205 is designed to suppress frequencies outside the range from 1930 to 1990 MHZ. The resultant signal from the second band-pass filter 205 is supplied to a second low noise amplifier 207. Selection of the desired frequency band may be accomplished by controlling the first and second low noise amplifiers 203, 207 in such a way that only one of them supplies an output to the remaining components of the receiver. These remaining components operate in the same way as the counterparts described above with respect to the single band receiver depicted in FIG. 1.

A problem with the above-described receivers is that strong in-band interferers may pass through the band selection filter without any suppression. These in-band interferers must first be amplified and down-converted before they can be suppressed by any channel selection filtering (e.g., by the channel selection filters 113, 115). These in-band interferers put very high linearity requirements on the front-end part of the receiver in order to avoid desensitization due to:

1. Strong signals driving the front-end into compression and thereby degrading the signal-to-noise ratio (SNR) in the receiver.

2. Strong signals causing reciprocal mixing of local oscillator phase noise.

3. Strong signals causing distortion through intermodulation caused by second or third order distortion (IP2, IP3). Second order distortion products due to AM interferers are a well-known problem in homodyne or low-IF receivers.

Another problem associated with multi-band receivers (e.g., the dual-band receiver illustrated in FIG. 2) is that these receivers add extra filters and switching mechanisms, even if the receive bands are relatively close, as in the DCS 1800 and PCS 1900 cellular communication systems. These extra components increase the complexity and cost of the receiver. The additional band switching devices also degrade the noise performance of the receiver due to the increased insertion loss between the antenna and the receiver front-end.

As a solution to the above identified problems, it has been proposed to move some of the channel selectivity to the filter preceding the front-end. For example, U.S. Pat. No. 5,065453 discloses an electrically-tunable band-pass filter for providing front-end selectivity in a superheterodyne radio receiver. The band-pass filter provides a narrow front-end filter which is tuned automatically as the local oscillator frequency is changed.

U.S. Pat. No. 5,752,179 discloses a selective RF circuit with varactor tuned and switched band-pass filters. In this arrangement, low-, mid- and highband-pass filters are selectively activated to cover a tuning range of the receiver. Each of these three filters is, itself, tunable when activated.

U.S. Pat. No. 5,150,085 discloses an electronically tunable front-end filter for use in a radio apparatus. The filter includes a plurality of isolated ceramic resonators, each having an associated varicap diode network to enable electronic tuning respective of ceramic resonators.

JP 2170627 A discloses a tunable filter interposed between two integrated circuits (ICs). The first of the ICs is an RF amplifier, while the second of the ICs is a mixer. The tunable filter is tuned by interlocking with a tuning voltage of an oscillating circuit.

Since, in these arrangements, the front-end filter acts as a band selection filter, it must be tunable to be able to select any channel within the receiver band. The tuning of this tunable filter must then be arranged in some clever way in order not to degrade performance for the received signal. That is, the tuning must always result in the best possible receiver for the received signal and at the same time offer some attenuation of strong in-band interferers located some channels away from the received signal.

Thus, there are very severe tuning requirements placed on the tunable front-end filter. However, it is difficult to tune these filters to the correct frequency because of spread in component values and because of temperature-related drift of the filter's center frequency. This is conventionally solved by production trimming, which is very time consuming if it has to be performed for all temperatures. Another problem with trimming only once in a factory is that this trim value remains constant while the tunable front-end filter changes its characteristics due to aging, temperature drift and/or moisture, which changes cannot be measured. Consequently, the receiver's performance degrades over time.

### SUMMARY

It is therefore an object of the present invention to provide a methods and apparatuses for tuning receiver front-end filters.

In accordance with one aspect of the present invention, the foregoing and other objects are achieved in a radio receiver, including a front-end circuit that generates a radio frequency (RF) signal, wherein the front-end circuit includes a first tunable band-pass filter that is capable of tunably selecting channels within at least one frequency band. A local oscillator circuit for generating a local oscillating signal is also included. A second tunable filter is coupled to receive a signal derived from the local oscillating signal and to generate therefrom a filtered local oscillating signal. A control unit is coupled to receive a signal derived from the filtered local oscillating signal. The control unit generates a control signal based on the signal derived from the filtered local oscillating signal. The control signal is supplied to the first tunable band-pass filter and to the second tunable filter for tuning the first tunable band-pass filter and the second tunable filter.

According to another aspect of the present invention, the radio receiver further includes an amplitude modulation (AM) detector that receives the filtered local oscillating signal, and generates therefrom the signal derived from the filtered local oscillating signal.

According to yet another aspect of the present invention, the control unit generates the control signal in a manner such that the control signal will cause the signal derived from the second filtered local oscillating signal to achieve a maximum value.

According to yet another aspect of the present invention, the radio receiver further includes a mixer for generating a baseband signal by mixing the RF signal with the local oscillating signal and a mixer for generating a baseband signal by mixing the RF signal with the filtered local oscillating signal.

According to yet another aspect of the present invention, each of the first and second tunable band-pass filters is tunable within a range spanning one predefined radio frequency band.

According to yet another aspect of the present invention, each of the first and second tunable band-pass filters is tunable within a range spanning at least two predefined radio frequency bands.

According to yet another aspect of the present invention, the radio receiver further includes a mixer for generating an intermediate frequency (IF) signal by mixing the RF signal with the local oscillating signal.

According to yet another aspect of the present invention, the radio receiver further includes an amplitude modulation (AM) detector that receives the filtered local oscillating signal, and generates therefrom the signal derived from the filtered local oscillating signal. The second tunable filter may be a narrow-band filter having a center frequency that is offset with respect to the tunable first band-pass filter. The control unit generates the control signal in a manner such that the control signal will cause the signal derived from the filtered local oscillating signal to achieve a maximum value.

According to yet another aspect of the present invention, the radio receiver further includes an amplitude modulation (AM) detector that receives the filtered local oscillating signal, and generates therefrom the signal derived from the filtered local oscillating signal. The second tunable filter may be a wide-band filter. The control unit generates the control signal by initially adjusting a pass-band of the second tunable filter below a predetermined value, and then adjusting the pass-band of the second tunable filter upward until a signal is detected at the output of the AM detector.

According to yet another aspect of the present invention, the radio receiver further includes an amplitude modulation (AM) detector that receives the filtered local oscillating signal, and generates therefrom the signal derived from the filtered local oscillating signal. The second tunable filter may be a wide-band filter. The control unit generates the control signal by initially adjusting a pass-band of the second tunable filter above a predetermined value, and then adjusting the pass-band of the second tunable filter downward until a signal is detected at the output of the AM detector.

According to yet another aspect of the present invention, the radio receiver further includes a second mixer for generating a baseband signal by mixing the IF signal with a second local oscillating signal.

According to yet another aspect of the present invention, the IF signal is a first IF signal, and a second mixer for generating a second intermediate frequency signal by mixing the first IF signal with a second local oscillating signal is included.

According to yet another aspect of the present invention, a radio receiver includes a front-end circuit that generates a radio frequency (RF) signal, the front-end circuit including a first tunable band-pass filter that is capable of tunably selecting channels within at least one frequency band. A local oscillator circuit is provided for generating a local oscillating signal and a control signal, the local oscillating circuit including a voltage controlled oscillator having a tunable resonator. The control signal is supplied to the first tunable band-pass filter and to the tunable resonator for tuning the tunable band-pass filter and the tunable resonator.

According to yet another aspect of the present invention, the front-end circuit further includes a second tunable band-pass filter that is capable of tunably selecting channels within the at least one frequency band. The control signal is further supplied to the second tunable band-pass filter for tuning the second tunable band-pass filter.

According to yet another aspect of the present invention, a radio receiver includes a front-end circuit that generates a radio frequency (RF) signal, the front-end circuit including an amplifier having a tunable load that is capable of tunably selecting channels within at least one frequency band. A local oscillator circuit is provided for generating a local oscillating signal and a control signal, the local oscillating circuit including a voltage controlled oscillator having a tunable resonator. the control signal is supplied to the tunable load and to the tunable resonator for tuning the tunable load and the tunable resonator.

### BRIEF DESCRIPTION OF THE DRAWINGS

The objects and advantages of the invention will be understood by reading the following detailed description in conjunction with the drawings in which:

FIG. 1 is a block diagram of a conventional single band homodyne receiver;

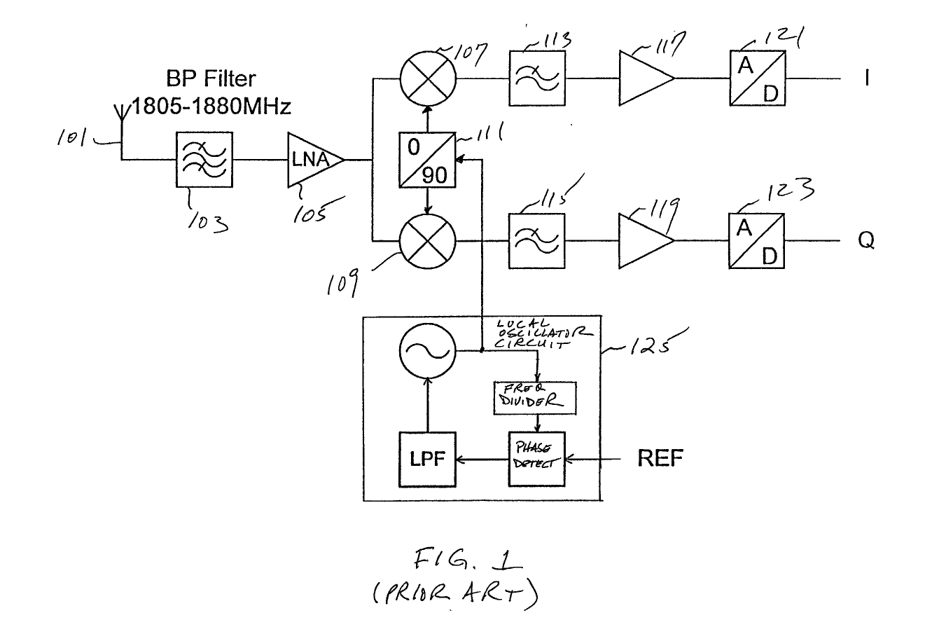

FIG. 2 is a block diagram of a conventional dual-band homodyne receiver;

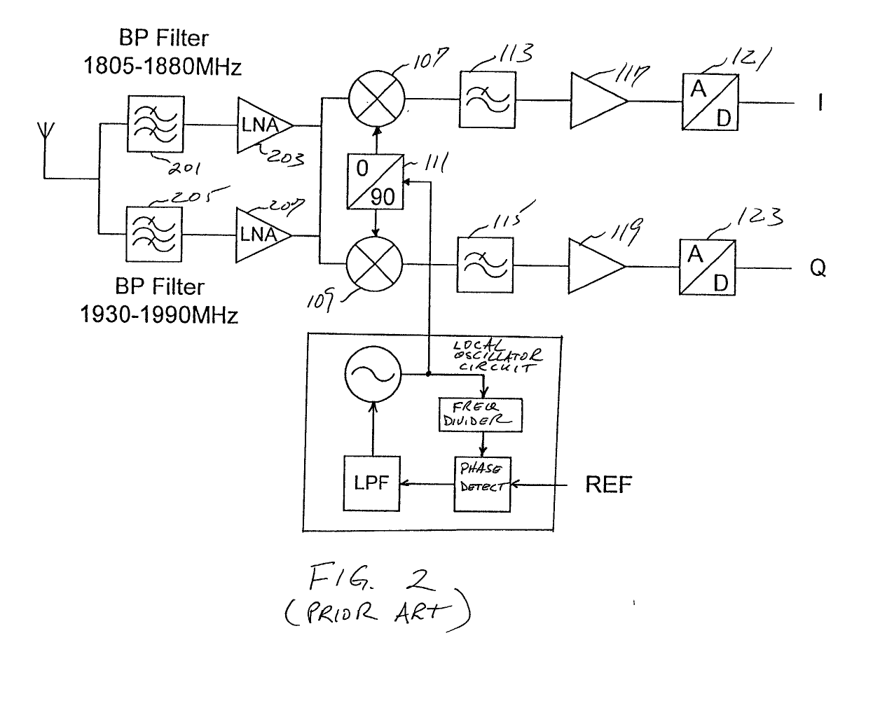

FIG. 3 is a block diagram of a single-band direct conversion radio receiver in accordance with the invention;

FIG. 4 is a block diagram of another embodiment of a single-band direct conversion radio receiver in accordance with the invention;

FIG. 5 is a block diagram of a dual band direct conversion radio receiver in accordance with the invention;

FIG. 6 is a block diagram of a dual band heterodyne receiver in accordance with the invention;

FIG. 7 is a block diagram of a dual-band double superheterodyne receiver in accordance with the invention.

FIG. 8 is a circuit diagram of a VCO having a tunable resonator;

FIG. 9 is a circuit diagram of an amplifier stage having a tunable load;

FIG. 10 is block diagram of a single-band direct conversion radio receiver utilizing a tuned resonator VCO;

FIG. 11 is block diagram of a single-band direct conversion radio receiver utilizing a tuned resonator VCO and a low noise amplifier having a tunable load; and

FIG. 12 is block diagram of a single-band direct conversion radio receiver utilizing a tuned resonator VCO and dual pre-selection filters.

### DETAILED DESCRIPTION

The various features of the invention will now be described with respect to the figures, in which like parts are identified with the same reference characters.

The invention involves the use of two tunable band-pass filters in a radio receiver. A first of these filters is used as the front-end selection filter. The second of the tunable band-pass filters receives a signal derived from the local oscillator signal. A control unit monitors a signal derived from the output of the second tunable band-pass filter, and generates a control signal for tuning the second filter in a manner that results in a desired output. The same control signal is used for tuning the first tunable band-pass filter. The first and second tunable band-pass filters are preferably matched, so that the control signal for tuning one of the filters will also accurately tune the other filter.

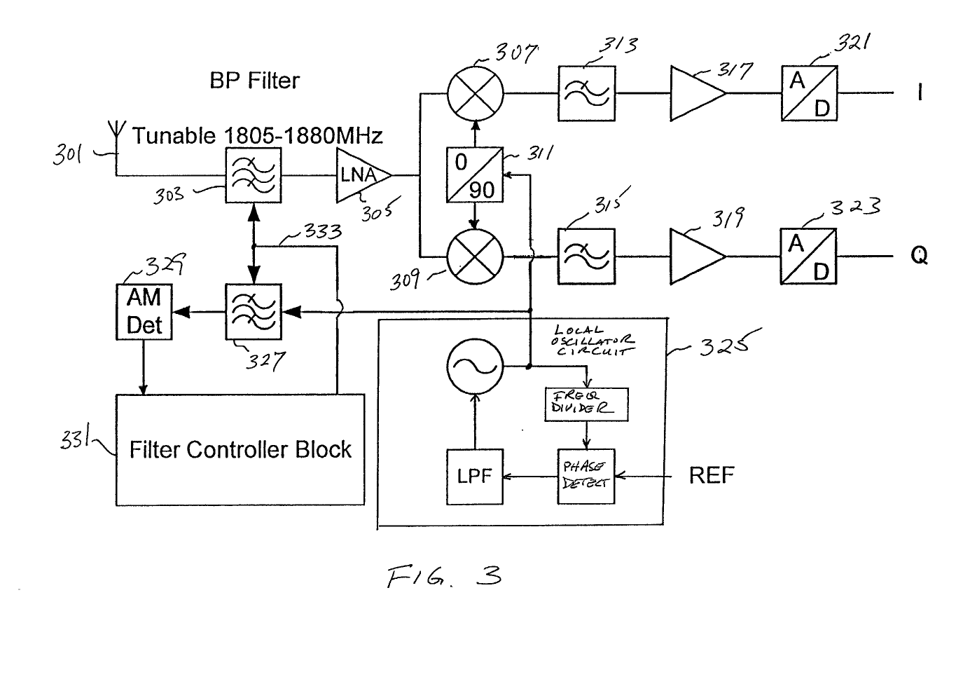

The various aspects of the invention will now be further described in connection with a number of exemplary embodiments. Referring first to FIG. 3, this is a block diagram of a single-band direct conversion radio receiver. As used herein, the term “direct conversion” may alternatively mean a zero-IF receiver, or a low-IF receiver (i.e., a receiver whose IF is in the same range as the channel spacing). In the exemplary receiver, I and Q digital signals are generated from a received RF signal. To accomplish this function, the RF signal is received by an antenna 301 and supplied to a tunable band-pass filter, herein referred to as a tunable pre-selection filter 303. The tunable pre-selection filter 303 is capable of tunably selecting channels within the desired frequency band. In the exemplary embodiment, the desired frequency band is the range from 1805 to 1880 MHZ.

From the output of the tunable pre-selection filter 303, the received signal is supplied to a low noise amplifier 305. After amplification, the signal is down-converted to respective in-phase (I) and quadrature (Q) baseband signals by first and second mixers 307, 309. This is accomplished by mixing the amplified received signal with respective locally-generated signals that each oscillate at (or near) the desired RF frequency, but which are 90 degrees out of phase with respect to one another. As indicated earlier, the purpose of separating the received signal into the I and Q baseband signals is to facilitate the demodulation of the signal (i.e., the extraction of the underlying information carried by the received signal). This aspect of the receiver operation is well-known, and need not be discussed here in further detail.

The respective locally-generated signals for use by the first and second mixers 307, 309 are created by first using a local oscillator circuit 325 to generate a signal of the desired frequency. The local oscillator circuit 325 is preferably implemented as a phase-locked loop (PLL). The signal from the local oscillator circuit 325 is then supplied to a phase-shifting circuit 311 that shifts the phase of the locally-generated signal by 90 degrees. The original (non-shifted) signal may then be supplied to the first mixer 307, while the phase-shifted signal may be supplied to the second mixer 309.

After down-conversion, the I and Q baseband signals are supplied to respective first and second channel selection filters 313, 315. The purpose of the first and second channel selection filters 313, 315 is to further separate the received signal from the in-band interferers. In addition, the first and second channel selection filters 313, 315 may condition their respective input signals for the purpose of avoiding aliasing that can result from sampling that is performed by downstream analog-to-digital converters. A third possible use of the first and second channel selection filters 313, 315 is for channel filtering, although this could alternatively be performed digitally by downstream receiver components.

After channel selection, the resultant I and Q signals could be subjected to further filtering and amplification (e.g., by respective first and second amplifiers 317, 319. Because this exemplary embodiment is a digital environment, the resultant analog signals are converted into digital form by respective first and second analog-to-digital (A/D) converters 321, 323.

For good performance, it is necessary to accurately tune the tunable pre-selection filter 303 so that the desired channel will be selected. To accomplish this function, the signal from the local oscillator circuit 325 is supplied not only to the phase-shifting circuit 311, but also to a second tunable band-pass filter, herein referred to as a tunable reference filter 327. The tunable reference filter 327 is preferably identical to the tunable pre-selection filter 303. Although filter characteristics may vary from component to component, it is generally the case that two identical filters will be well matched when manufactured on the same component (i.e., the same IC). Thus, a control signal for tuning one such filter to achieve a desired filtering characteristic may also be used for tuning the other filter to achieve the same filtering characteristic.

Continuing with a description of the exemplary embodiment, the output of the tunable reference filter 327 is supplied to an AM detector 329. The output of the AM detector 329 is supplied to a filter controller block 331, which may be a hard-wired controller, a programmable controller executing a suitable set of program instructions, or any combination of the above. The filter controller block 331 is configured to monitor the signal from the AM detector 329, and to generate a control signal 333 that adjusts the tunable reference filter 327 in a manner that maximizes the monitored signal from the AM detector 329. In accordance with one aspect of the invention, this same control signal 333 is also supplied to a control input of the tunable pre-selection filter 303. In the case of a homodyne receiver, this arrangement will cause the tunable pre-selection filter 303 to select (i.e., pass) those components of the received signal having the same frequency as the local oscillator signal. In the case of a low-IF receiver, this arrangement will cause the tunable pre-selection filter 303 to select (i.e., pass) those components of the received signal having a frequency that is slightly offset from the local oscillator frequency. This offset can be tolerable if the bandwidth of the filter is wide enough.

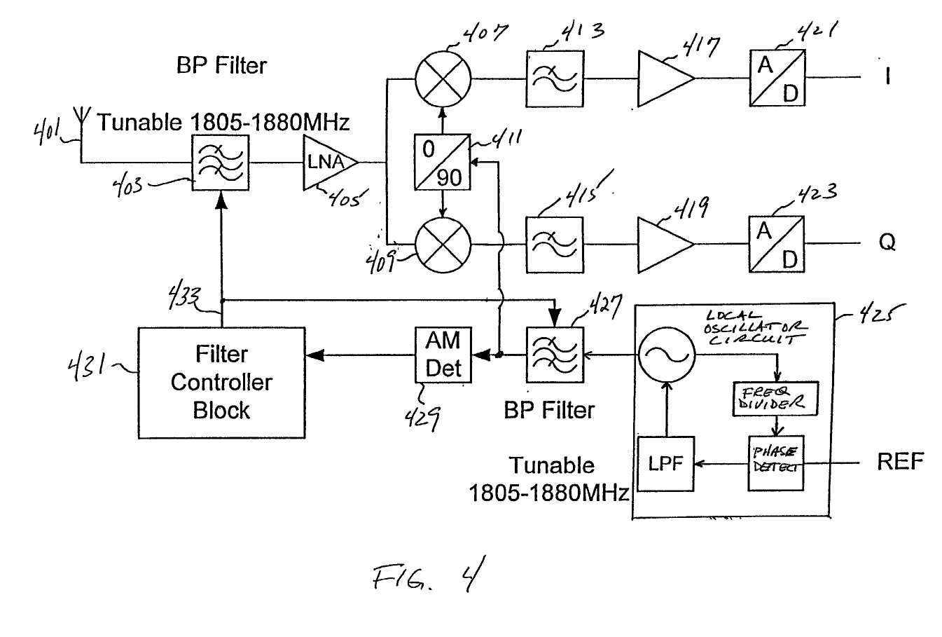

Other aspects of the invention will now be further described in connection with a an alternative exemplary embodiment. Referring now to FIG. 4, this is a block diagram of a single-band direct conversion radio receiver. Again, as used herein, the term “direct conversion” may alternatively mean a zero-IF receiver, or a low-IF receiver (i.e., a receiver whose IF is in the same range as the channel spacing). The exemplary receiver of FIG. 4 is similar in operation to the one illustrated in FIG. 3. In particular, I and Q digital signals are generated from a received RF signal. To accomplish this function, the RF signal is received by an antenna 401 and supplied to a tunable band-pass filter, herein referred to as a tunable pre-selection filter 403. The tunable pre-selection filter 403 is capable of tunably selecting channels within the desired frequency band. In the exemplary embodiment, the desired frequency band is the range from 1805 to 1880 MHZ.

From the output of the tunable pre-selection filter 403, the received signal is supplied to a low noise amplifier 405. After amplification, the signal is down-converted to respective in-phase (I) and quadrature (Q) baseband signals by first and second mixers 407, 409. This is accomplished by mixing the amplified received signal with respective locally-generated signals that each oscillate at (or near) the desired RF frequency, but which are 90 degrees out of phase with respect to one another. As indicated earlier, the purpose of separating the received signal into the I and Q baseband signals is to facilitate the demodulation of the signal (i.e., the extraction of the underlying information carried by the received signal). This aspect of the receiver operation is well-known, and need not be discussed here in further detail.

The respective locally-generated signals for use by the first and second mixers 407, 409 are created by first using a local oscillator circuit 425 to generate a signal of the desired frequency. The local oscillator circuit is preferably implemented as a PLL. This embodiment differs from the one described above with reference to FIG. 3 in that the signal supplied by the local oscillator circuit 425 is supplied to a second tunable band-pass filter, herein referred to as a tunable reference filter 427. The tunable reference filter 427 is preferably identical to the tunable pre-selection filter 403.

The output of the tunable reference filter 427 is supplied to a phase-shifting circuit 411 that shifts the phase of the locally-generated signal by 90 degrees. The original (non-shifted) signal may then be supplied to the first mixer 407, while the phase-shifted signal may be supplied to the second mixer 409.

After down-conversion, the I and Q baseband signals are supplied to respective first and second channel selection filters 413, 415. The purpose of the first and second channel selection filters 413, 415 is to further separate the received signal from the in-band interferers. In addition, the first and second channel selection filters 413, 415 may condition their respective input signals for the purpose of avoiding aliasing that can result from sampling that is performed by downstream analog-to-digital converters. A third possible use of the first and second channel selection filters 413, 415 is for channel filtering, although this could alternatively be performed digitally by downstream receiver components.

After channel selection, the resultant I and Q signals could be subjected to further filtering and amplification (e.g., by respective first and second amplifiers 417, 419. Because this exemplary embodiment is a digital environment, the resultant analog signals are converted into digital form by respective first and second analog-to-digital (A/D) converters 421, 423.

For good performance, it is necessary to accurately tune the tunable pre-selection filter 403 so that the desired channel will be selected. To accomplish this function, the signal supplied at the output of the tunable reference filter 427 is supplied to an AM detector 429. The output of the AM detector 429 is supplied to a filter controller block 431, which may be a hard-wired controller, a programmable controller executing a suitable set of program instructions, or any combination of the above. The filter controller block 431 is configured to monitor the signal from the AM detector 429, and to generate a control signal 433 that adjusts the tunable reference filter 427 in a manner that maximizes the monitored signal from the AM detector 429. In accordance with one aspect of the invention, this same control signal 433 is also supplied to a control input of the tunable pre-selection filter 403. In the case of a homodyne receiver, this arrangement will cause the tunable pre-selection filter 403 to select (i.e., pass) those components of the received signal having the same frequency as the local oscillator signal. In the case of a low-IF receiver, this arrangement will cause the tunable pre-selection filter 403 to select (i.e., pass) those components of the received signal having a frequency that is slightly offset from the local oscillator frequency. This offset can be tolerable if the bandwidth of the filter is wide enough.

Because the tunable pre-selection filter 403 and the tunable reference filter 427 are preferably identical to one another, they will be well matched when manufactured on the same integrated circuit. Consequently, the control signal 433 is useful not only for tuning the tunable reference filter 427, but also for accurately tuning the tunable pre-selection filter 403. In this respect, the embodiment of FIG. 4 is similar to that described earlier with reference to FIG. 3. The embodiment of FIG. 4 has additional advantages, however, in that the signal supplied to the phase-shifting circuit 411 is filtered by the tunable reference filter 427, and is therefore improved with respect to phase noise. As a result, the VCO in the local oscillator circuit 425 can be made simpler (i.e., it can be designed to have a lower Q-value in the resonator). Alternatively, the VCO can be designed to consume less power. In some embodiments, designers might compromise their solutions, so that the VCO in the local oscillator circuit 425 is made somewhat simpler, while also having a VCO that consumes somewhat less power. Moreover, these advantages are achieved without adding any additional complexity to the overall receiver.

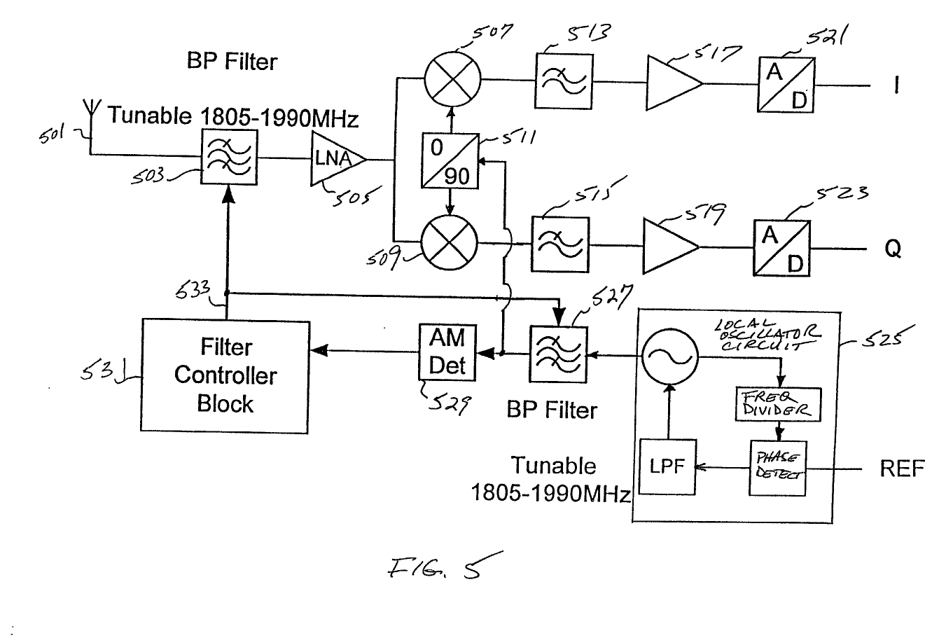

FIG. 5 is a block diagram of another exemplary embodiment of a receiver in accordance with the invention. The arrangement of FIG. 5 is similar to that of FIG. 4, but is designed to effect a dual band direct conversion radio receiver. Again, as used herein, the term “direct conversion” may alternatively mean a zero-IF receiver, or a low-IF receiver (i.e., a receiver whose IF is in the same range as the channel spacing). In operation, the exemplary receiver of FIG. 5 generates I and Q digital signals from a received RF signal. To accomplish this function, the RF signal is received by an antenna 501 and supplied to a tunable band-pass filter, herein referred to as a tunable pre-selection filter 503. The tunable pre-selection filter 503 is capable of tunably selecting channels within either of the desired frequency bands. In the exemplary embodiment, the desired frequency bands cover a combined range from 1805 to 1990 MHZ, so the tunable pre-selection filter 503 is tunable within this range.

From the output of the tunable pre-selection filter 503, the received signal is supplied to a low noise amplifier 505. After amplification, the signal is down-converted to respective in-phase (I) and quadrature (Q) baseband signals by first and second mixers 507, 509. This is accomplished by mixing the amplified received signal with respective locally-generated signals that each oscillate at (or near) the desired RF frequency, but which are 90 degrees out of phase with respect to one another. As indicated earlier, the purpose of separating the received signal into the I and Q baseband signals is to facilitate the demodulation of the signal (i.e., the extraction of the underlying information carried by the received signal). This aspect of the receiver operation is well-known, and need not be discussed here in further detail.

The respective locally-generated signals for use by the first and second mixers 507, 509 are created by first using a local oscillator circuit 525 to generate a signal of the desired frequency. The local oscillator circuit 525 is preferably implemented as a PLL. Like the embodiment of FIG. 4, the signal supplied by the local oscillator circuit 525 in the receiver of FIG. 5 is supplied to a second tunable band-pass filter, herein referred to as a tunable reference filter 527. The tunable reference filter 527 is preferably identical to the tunable pre-selection filter 503.

The output of the tunable reference filter 527 is supplied to a phase-shifting circuit 511 that shifts the phase of the locally-generated signal by 90 degrees. The original (non-shifted) signal may then be supplied to the first mixer 507, while the phase-shifted signal may be supplied to the second mixer 509.

After down-conversion, the I and Q baseband signals are supplied to respective first and second channel selection filters 513, 515. The purpose of the first and second channel selection filters 513, 515 is to further separate the received signal from the in-band interferers. In addition, the first and second channel selection filters 513, 515 may condition their respective input signals for the purpose of avoiding aliasing that can result from sampling that is performed by downstream analog-to-digital converters. A third possible use of the first and second channel selection filters 513, 515 is for channel filtering, although this could alternatively be performed digitally by downstream receiver components.

After channel selection, the resultant I and Q signals could be subjected to further filtering and amplification (e.g., by respective first and second amplifiers 517, 519. Because this exemplary embodiment is a digital environment, the resultant analog signals are converted into digital form by respective first and second analog-to-digital (A/D) converters 521, 523.

For good performance, it is necessary to accurately tune the tunable pre-selection filter 503 so that the desired channel will be selected. To accomplish this function, the signal supplied at the output of the tunable reference filter 527 is supplied to an AM detector 529. The output of the AM detector 529 is supplied to a filter controller block 531, which may be a hard-wired controller, a programmable controller executing a suitable set of program instructions, or any combination of the above. The filter controller block 531 is configured to monitor the signal from the AM detector 529, and to generate a control signal 533 that adjusts the tunable reference filter 527 in a manner that maximizes the monitored signal from the AM detector 529. In accordance with one aspect of the invention, this same control signal 533 is also supplied to a control input of the tunable pre-selection filter 503. In the case of a homodyne receiver, this arrangement will cause the tunable pre-selection filter 503 to select (i.e., pass) those components of the received signal having the same frequency as the local oscillator signal. In the case of a low-IF receiver, this arrangement will cause the tunable pre-selection filter 503 to select (i.e., pass) those components of the received signal having a frequency that is slightly offset from local oscillator frequency. This offset can be tolerable if the bandwidth of the filter is wide enough.

Because the tunable pre-selection filter 503 and the tunable reference filter 527 are preferably identical to one another, they will be well matched when manufactured on the same integrated circuit. Consequently, the control signal 533 is useful not only for tuning the tunable reference filter 527, but also for accurately tuning the tunable pre-selection filter 503. Like the embodiment of FIG. 4, the embodiment of FIG. 5 has advantages deriving from the fact that the signal supplied to the phase-shifting circuit 511 is filtered by the tunable reference filter 527, and is therefore improved with respect to phase noise. As a result, the VCO in the local oscillator circuit 525 can be made simpler (i.e., it can be designed to have a lower Q-value in the resonator). Alternatively, the VCO can be designed to consume less power. In some embodiments, designers might compromise their solutions, so that the VCO in the local oscillator circuit 425 is made somewhat simpler, while also having a VCO that consumes somewhat less power. Moreover, these advantages are achieved without adding any additional complexity to the overall receiver.

The embodiment of FIG. 5 has the further advantage of providing a single receiver that is capable of being used for two bands without having to add additional filters and front-end circuitry. Thus complexity and cost are reduced, compared to conventional receivers. In other alternative embodiments, the tunable pre-selection filter 503 and the tunable reference filter 527 can be designed to have an even wider range, spanning more than two frequency bands. Thus, a receiver can similarly be designed that is capable of multi-band operation.

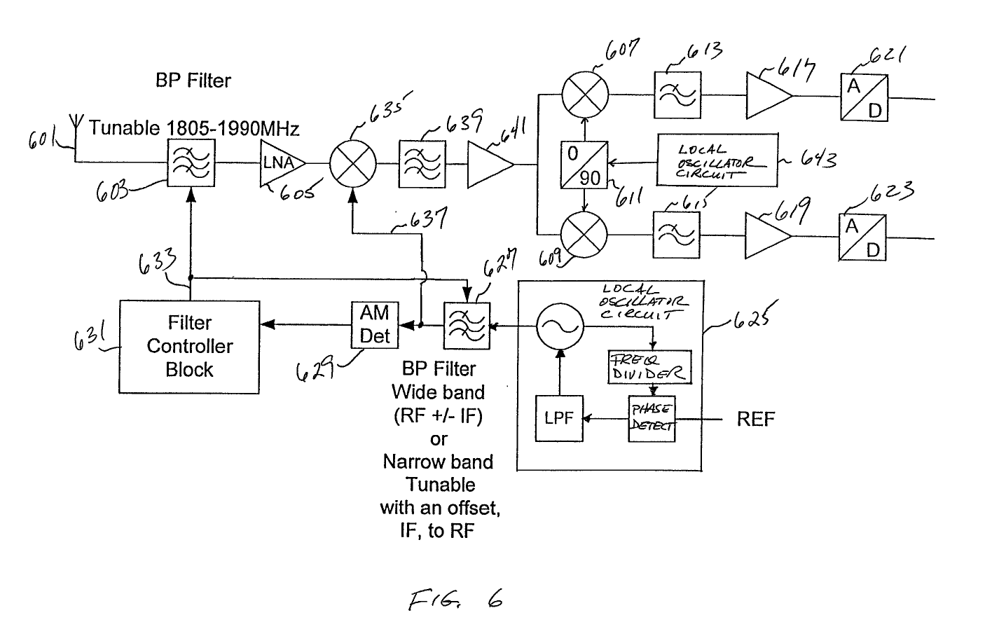

Turning now to yet another embodiment of the invention, FIG. 6 depicts a dual-band heterodyne receiver. Like the earlier described receivers, the exemplary receiver of FIG. 6 generates I and Q digital signals from a received RF signal. To accomplish this function, the RF signal is received by an antenna 601 and supplied to a tunable band-pass filter, herein referred to as a tunable preselection filter 603. The tunable pre-selection filter 603 is capable of tunably selecting channels within either of the desired frequency bands. In the exemplary embodiment, the desired frequency bands cover a combined range from 1805 to 1990 MHZ, so the tunable pre-selection filter 603 is tunable within this range.

From the output of the tunable pre-selection filter 603, the received signal is supplied to a low noise amplifier 605. After amplification, the signal is converted to an IF signal by an IF mixer 635, that mixes the amplified received signal with a first local oscillator signal 637. The frequency of the IF signal is related to the difference between the RF frequency and the frequency of the first local oscillator signal 637.

To create the first local oscillator signal 637, a first local oscillator circuit 625 generates a signal having a suitable frequency for mixing with the amplified RF signal. The first local oscillator circuit 625 is preferably implemented as a PLL. The signal generated by the first local oscillator circuit 625 is supplied to a second tunable band-pass filter, herein referred to as a tunable reference filter 627. In one embodiment, the tunable reference filter 627 is a narrow band-pass filter, having a center frequency that is offset with respect to the center frequency of the tunable pre-selection filter 603. The amount of the offset should be approximately the frequency of the IF signal to be generated. For example, if the intermediate frequency is 90 MHZ, then the offset should be approximately 90 MHZ.

The output of the IF mixer 635 is supplied to another band-pass filter 639. The band-pass filter 639 contributes to the overall channel selection filtering by suppressing noise outside the channel(s) of interest. Typically, the bandwidth of band-pass filter 639 is much smaller than the bandwidth of the tunable pre-selection filter 603. The output of the band-pass filter 639 is amplified by an IF amplifier 641, and then down-converted to respective in-phase (I) and quadrature (Q) baseband signals by first and second mixers 607, 609. This is accomplished by mixing the amplified received signal with respective locally-generated signals that each oscillate at (or near) the IF frequency, but which are 90 degrees out of phase with respect to one another. As indicated earlier, the purpose of separating the received signal into the I and Q baseband signals is to facilitate the demodulation of the signal (i.e., the extraction of the underlying information carried by the received signal). This aspect of the receiver operation is well-known, and need not be discussed here in further detail.

respective locally-generated signals for use by the first and second mixers 607, 609 are created by first using a second local oscillator circuit 643 to generate a signal at or near the frequency of the IF signal. This signal is then supplied to a phase-shifting circuit 611 that shifts the phase of the locally-generated signal by 90 degrees. The original (non-shifted) signal may then be supplied to the first mixer 607, while the phase-shifted signal may be supplied to the second mixer 609.

After down-conversion, the I and Q baseband signals are supplied to respective first and second channel selection filters 613, 615. The purpose of the first and second channel selection filters 613, 615 is to further separate the received signal from the in-band interferers. In addition, the first and second channel selection filters 613, 615 may condition their respective input signals for the purpose of avoiding aliasing that can result from sampling that is performed by downstream analog-to-digital converters. A third possible use of the first and second channel selection filters 613, 615 is for channel filtering, although this could alternatively be performed digitally by downstream receiver components.

After channel selection, the resultant I and Q signals could be subjected to further filtering and amplification (e.g., by respective first and second amplifiers 617, 619. Because this exemplary embodiment is a digital environment, the resultant analog signals are converted into digital form by respective first and second analog-to-digital (A/D) converters 621, 623.

For good performance, it is necessary to accurately tune the tunable pre-selection filter 603 so that the desired channel will be selected. To accomplish this function, the signal supplied at the output of the tunable reference filter 627 is further supplied to an AM detector 629. The output of the AM detector 629 is supplied to a filter controller block 631, which may be a hard-wired controller, a programmable controller executing a suitable set of program instructions, or any combination of the above. The filter controller block 631 is configured to monitor the signal from the AM detector 629, and to generate a control signal 633 that adjusts the tunable reference filter 627 in a manner that maximizes the monitored signal from the AM detector 629. In accordance with one aspect of the invention, this same control signal 633 is also supplied to a control input of the tunable pre-selection filter 603. This arrangement will cause the tunable pre-selection filter 603 to select (i.e., pass) those components of the received signal having the frequency of the desired RF signal.

Because the tunable pre-selection filter 603 and the tunable reference filter 627 are preferably manufactured on the same integrated circuit, they will be well matched with respect to one another. Consequently, the control signal 633 is useful not only for tuning the tunable reference filter 627, but also for accurately tuning the tunable pre-selection filter 603.

In an alternative embodiment, the tunable reference filter 627 may be a wider band-pass filter, with a bandwidth at least as wide as the offset frequency between the local oscillator and the desired RF signal. In this case, the filter bandwidth should be wide enough to avoid attenuation of both the signal from the first local oscillator circuit 625 and the desired RF signal, when the center frequency of the filter is tuned to exactly between the local oscillator frequency and the desired RF signal. For example, if the intermediate frequency is 90 MHZ, the bandwidth of the tunable reference filter 627 should be at least 90 MHZ.

In this embodiment, the tuning of the tunable pre-selection filter 603 is again based on the same signal that tunes the tunable reference filter 627. However, in this case the filter controller block 631 does not attempt to maximize the signal supplied at the output of the AM detector 629. Instead, tuning starts by initially setting the tunable reference filter 627 to a frequency that is alternatively higher or lower than the expected frequency band of the filter. At this point, no detectable signal should be supplied by the AM detector 629. Then, the tunable reference filter 627 is adjusted down or up (depending on the initial setting) until the filter control block 631 senses a detectable signal from the AM detector 629. At this point, the tunable reference filter 627 as well as the tunable pre-selection filter 603 are tuned.

For example, consider a case in which the frequency of the local oscillator circuit 625 is higher than the RF frequency. If the tunable reference filter 627 is initially set to a frequency lower than the RF frequency, no detectable signal is supplied by the AM detector 629. The pass-band of the tunable reference filter 627 is then adjusted upward by the filter controller block 631 until the filter controller block 631 senses a detectable signal at the output of the AM detector 629. At this point, the signal from the local oscillator circuit 625 will be in the high part of the tunable reference filter's pass-band, while the RF signal will be in the low part of this pass-band.

In another example, the frequency of the local oscillator circuit 625 may be lower than the RF frequency. In this case, the tunable reference filter 627 is initially set to a frequency higher than the RF frequency, so that no detectable signal is supplied by the AM detector 629. The pass-band of the tunable reference filter 627 is then adjusted downward by the filter controller block 631 until the filter controller block 631 senses a detectable signal at the output of the AM detector 629. At this point, the signal from the local oscillator circuit 625 will be in the low part of the tunable reference filter's pass-band, while the RF signal will be in the high part of this pass-band.

Like earlier embodiments, all of the embodiments illustrated by FIG. 6 have the advantage of providing a single receiver that is capable of being used for two bands without having to add additional filters and front-end circuitry. Thus complexity and cost are reduced, compared to conventional receivers. In other alternative embodiments, the tunable pre-selection filter 603 and the tunable reference filter 627 can be designed to have an even wider range, spanning more than two frequency bands. Thus, a receiver can similarly be designed that is capable of multi-band operation.

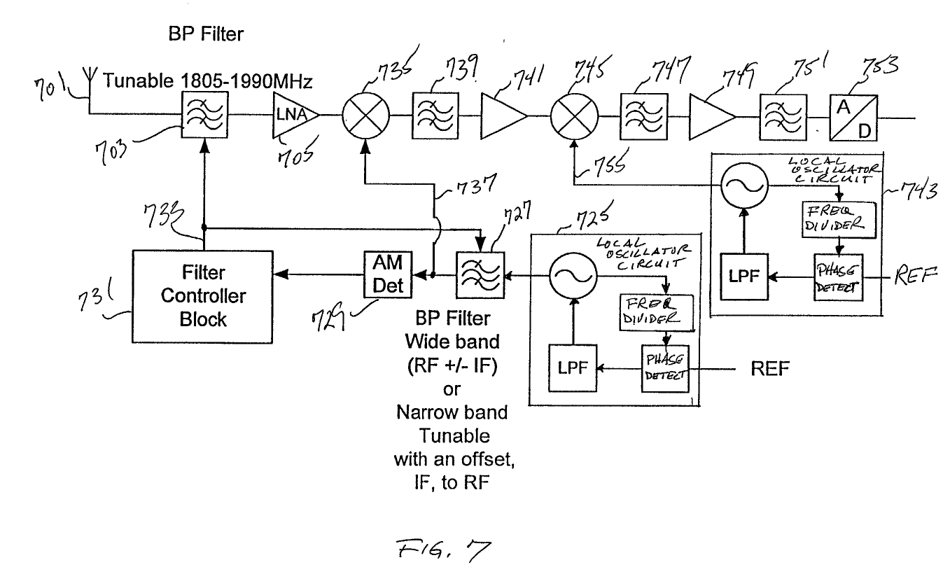

Turning now to yet another embodiment of the invention, FIG. 7 depicts a dual-band double superheterodyne receiver. Unlike the earlier described receivers, the exemplary receiver of FIG. 7 does not generate I and Q digital signals from a received RF signal. Instead, it generates digital samples directly from an intermediate frequency signal. To accomplish this function, the RF signal is received by an antenna 701 and supplied to a tunable band-pass filter, herein referred to as a tunable pre-selection filter 703. The tunable pre-selection filter 703 is capable of tunably selecting channels within either of the desired frequency bands. In the exemplary embodiment, the desired frequency bands cover a combined range from 1805 to 1990 MHZ, so the tunable pre-selection filter 703 is tunable within this range.

From the output of the tunable pre-selection filter 703, the received signal is supplied to a low noise amplifier 705. After amplification, the signal is converted to a first IF signal by a first IF mixer 735, that mixes the amplified received signal with a first local oscillator signal 737. The frequency of the first IF signal is related to the difference between the RF frequency and the frequency of the first local oscillator signal 737.

To create the first local oscillator signal 737, a first local oscillator circuit 725 generates a signal having a suitable frequency for mixing with the amplified RF signal. The first local oscillator circuit 725 is preferably implemented as a PLL. The signal generated by the first local oscillator circuit 725 is supplied to a second tunable band-pass filter, herein referred to as a tunable reference filter 727. In one embodiment, the tunable reference filter 727 is a narrow band-pass filter, having a center frequency that is offset with respect to the center frequency of the tunable pre-selection filter 703. The amount of the offset should be approximately the frequency of the first IF signal to be generated. For example, if the first intermediate frequency is 90 MHZ, then the offset should be approximately 90 MHZ.

The output of the first IF mixer 735 is supplied to another band-pass filter 739. The band-pass filter 739 contributes to the overall channel selection filtering by suppressing noise outside the channel(s) of interest. Typically, the bandwidth of band-pass filter 739 is much smaller than the bandwidth of the tunable pre-selection filter 703. The output of the band-pass filter 739 is amplified by a first IF amplifier 741 and then down-converted to a second intermediate frequency by means of a second mixer 745, that mixes the amplified first IF signal with a second local oscillator signal 755. The frequency of the second IF signal is related to the difference between the first IF frequency and the frequency of the second local oscillator signal 755.

To create the second local oscillator signal 755, a second local oscillator circuit 743 generates a signal having a suitable frequency for mixing with the amplified first IF signal. The second local oscillator circuit 743 is preferably implemented as a PLL.

The second IF signal, supplied by the second mixer 745, is then processed by yet another band-pass filter 747. The resultant signal is then further amplified by an amplifier 749 and again filtered by still another band-pass filter 751. The band-pass filters 747 and 751 perform further channel selection filtering. Only one of these channel selection filters need be employed if the overall channel performance requirements permit, or if a sufficiently high-performance channel selection filter is employed. The signal at the output of this band-pass filter 751, which is at the second IF frequency, is then converted to a digital form by an A/D converter 753.

For good performance, it is necessary to accurately tune the tunable pre-selection filter 703 so that the desired channel will be selected. To accomplish this function, the signal supplied at the output of the tunable reference filter 727 is further supplied to an AM detector 729. The output of the AM detector 729 is supplied to a filter controller block 731, which may be a hard-wired controller, a programmable controller executing a suitable set of program instructions, or any combination of the above. The filter controller block 731 is configured to monitor the signal from the AM detector 729, and to generate a control signal 733 that adjusts the tunable reference filter 727 in a manner that maximizes the monitored signal from the AM detector 729. In accordance with one aspect of the invention, this same control signal 733 is also supplied to a control input of the tunable pre-selection filter 703. This arrangement will cause the tunable pre-selection filter 703 to select (i.e., pass) those components of the received signal having the frequency of the desired RF signal.

Because the tunable pre-selection filter 703 and the tunable reference filter 727 are preferably manufactured on the same integrated circuit, they will be well matched with respect to one another. Consequently, the control signal 733 is useful not only for tuning the tunable reference filter 727, but also for accurately tuning the tunable pre-selection filter 703.

In an alternative embodiment, the tunable reference filter 727 may be a wider band-pass filter, with a bandwidth at least as wide as the offset frequency between the local oscillator and the desired RF signal. In this case, the filter bandwidth should be wide enough to avoid attenuation of both the signal from the first local oscillator circuit 725 and the desired RF signal, when the center frequency of the filter is tuned to a frequency exactly between the local oscillator frequency and the desired RF signal. For example, if the first intermediate frequency is 90 MHZ, the bandwidth of the tunable reference filter 727 should be at least 90 MHZ.

In this embodiment, the tuning of the tunable pre-selection filter 703 is again based on the same signal that tunes the tunable reference filter 727. However, in this case the filter controller block 731 does not attempt to maximize the signal supplied at the output of the AM detector 729. Instead, tuning starts by initially setting the tunable reference filter 727 to a frequency that is alternatively higher or lower than the expected frequency band of the filter. At this point, no detectable signal should be supplied by the AM detector 729. Then, the tunable reference filter 727 is adjusted down or up (depending on the initial setting) until the filter control block 731 senses a detectable signal from the AM detector 729. At this point, the tunable reference filter 727 as well as the tunable pre-selection filter 703 are tuned.

For example, consider a case in which the frequency of the first local oscillator circuit 725 is higher than the RF frequency. If the tunable reference filter 727 is initially set to a frequency lower than the RF frequency, no detectable signal is supplied by the AM detector 729. The pass-band of the tunable reference filter 727 is then adjusted upward by the filter controller block 731 until the filter controller block 731 senses a detectable signal at the output of the AM detector 729. At this point, the signal from the first local oscillator circuit 725 will be in the high part of the tunable reference filter's pass-band, while the RF signal will be in the low part of this pass-band.

In another example, the frequency of the first local oscillator circuit 725 may be lower than the RF frequency. In this case, the tunable reference filter 727 is initially set to a frequency higher than the RF frequency, so that no detectable signal is supplied by the AM detector 729. The pass-band of the tunable reference filter 727 is then adjusted downward by the filter controller block 731 until the filter controller block 731 senses a detectable signal at the output of the AM detector 729. At this point, the signal from the first local oscillator circuit 725 will be in the low part of the tunable reference filter's pass-band, while the RF signal will be in the high part of this pass-band.

Like earlier embodiments, all of the embodiments illustrated by FIG. 7 have the advantage of providing a single receiver that is capable of being used for two bands without having to add additional filters and front-end circuitry. Thus complexity and cost are reduced, compared to conventional receivers. In other alternative embodiments, the tunable pre-selection filter 703 and the tunable reference filter 727 can be designed to have an even wider range, spanning more than two frequency bands. Thus, a receiver can similarly be designed that is capable of multi-band operation.

In each of the exemplary embodiments described above, the tunable reference filter has been illustrated as a separate component, distinct from other illustrated components. However, for those embodiments that employ direct conversion of the RF signal to a baseband signal (e.g., embodiments described above with reference to any of FIGS. 3, 4 or 5), the tunable reference filter may be implemented as a part of the local oscillator circuit. This derives from the fact that the resonator in a local oscillator behaves like a band-pass filter. In such embodiments, the benefits of the invention can be achieved without having to introduce additional parts associated with the tunable reference filter and/or the AM detector and filter controller block components.

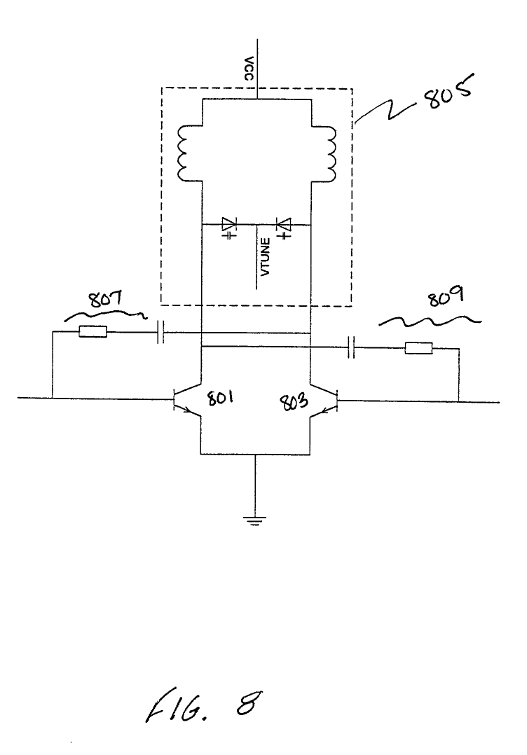

For example, FIG. 8 depicts a VCO having a pair of input transistors 801, 803 that are coupled in a feedback configuration through passive R/C networks 807 and 809. The circuit further comprises a tunable resonator 805 that operates as a band-pass filter. While a specific VCO topology has been depicted, it will be understood that any conventional VCO configuration may be employed, provided the tunable resonator 805 may be incorporated into the chosen design. Furthermore, the biasing of such circuits is well-known, and need not be discussed here in further detail.

The tuned resonator VCO topology shown in FIG. 8 may be used in any of the local oscillator circuits 325, 425, 525 shown in FIGS. 3, 4, or 5. Each of the local oscillator circuits 325, 425, 525 are preferably implemented as PLLs. A control signal VTUNE is generated by a respective PLL and is used to bias the tunable resonator 805 of the tuned resonator VCO causing the local oscillator circuits to produce a locally generated signal at (or near) the desired RF frequency.

The tunable resonator 805 is preferably identical to any of the tunable pre-selection filters 303, 403, 503, and will generally be well matched to the pre-selection filters when manufactured on the same component (i.e., the same IC). The generated control signal VTUNE used for tuning the tuned resonator VCO may then be used for tuning the pre-selection filters 303, 403, 503 to achieve the same filtering characteristic. Thus, the tuned resonator VCO may be used to reduce the overall component count for the direct conversion radio receivers shown in FIGS. 3, 4, and 5 by eliminating the need for the AM detector and filter controller block components.

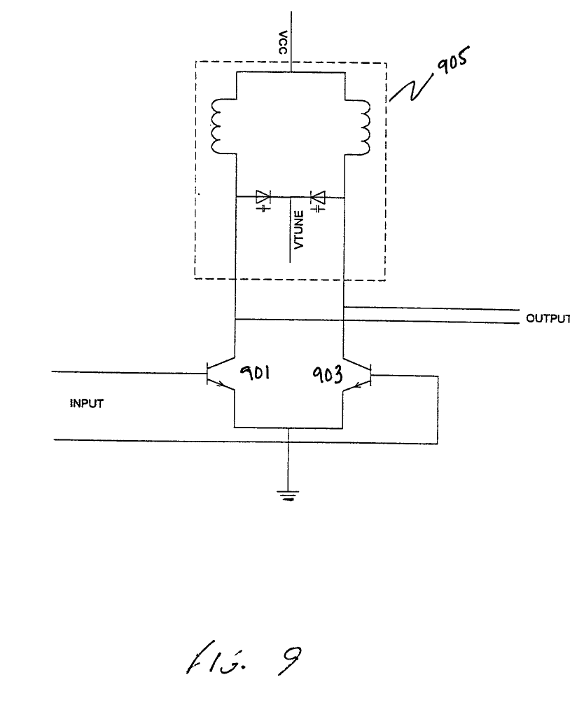

To further reduce the radio receiver component count and increase the overall level of integration in the receiver, the need for the separate tunable pre-selection filters 303, 403, 503 shown in FIGS. 3, 4, and 5 may be eliminated by either completely, or partially, incorporating the pre-selection filter function into any of the low noise amplifiers 305, 405, 505. Such a tunable low noise amplifier is shown in FIG. 9. The tunable amplifier comprises a pair of input transistors 901, 903 that are coupled to a tunable load impedance 905. The tunable load impedance 905 operates as a band-pass filter, passing only those amplified input signals to the output terminals of the amplifier that are at (or near) the desired RF frequency.

The filtering characteristics of the tunable amplifier may be adjusted by changing a control signal input VTUNE. The tunable load impedance 905 is preferably identical to tunable resonator 805, and will generally be well matched to the resonator 805 when manufactured on the same component (i.e., the same IC). The control signal VTUNE generated by a respective local oscillator circuit 325, 425, 525 using a tuned resonator VCO is preferably coupled to the control signal input VTUNE of the tunable amplifier. This arrangement will cause the tunable amplifier to select (i.e., pass) those components of the received signal having the same frequency as the corresponding generated local oscillator signal. Thus, by employing a tunable amplifier in combination with a matched tuned resonator VCO, the desired channel selection in the receiver can be achieved without the need for having a separate tunable pre-selection filter, AM detector, or filter controller block.

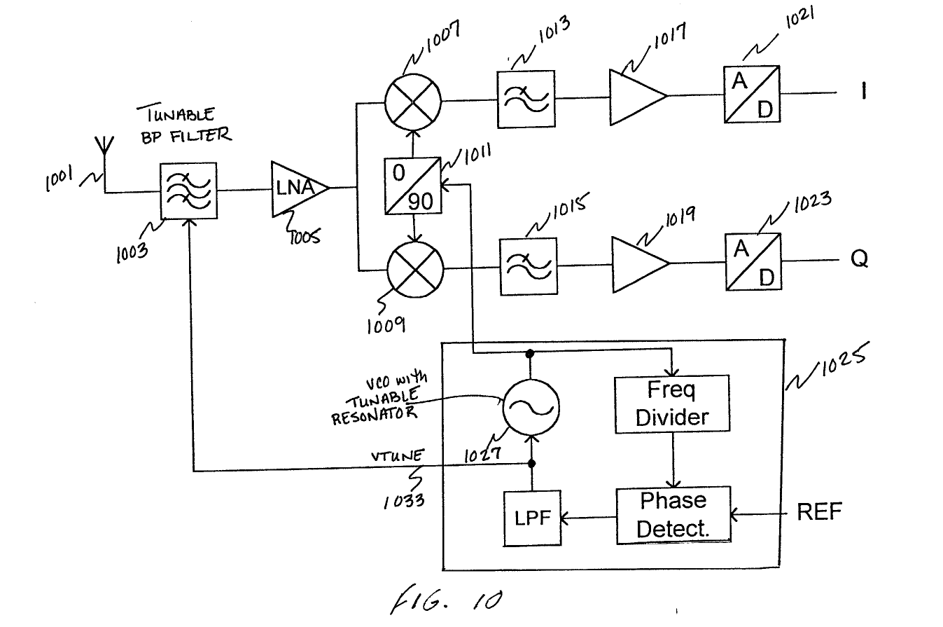

Various exemplary embodiments of radio receivers using tuned resonator VCOs and tunable low noise amplifiers as described above will now be presented. Referring first to FIG. 10, this is a block diagram of a single-band direct conversion radio receiver utilizing a tuned resonator VCO 1027 as shown in FIG. 8. Again, as used herein, the term “direct conversion” may alternatively mean a zero-IF receiver, or a low-IF receiver (i.e., a receiver whose IF is in the same range as the channel spacing). As in the earlier presented embodiments, in-phase (I) and quadrature (Q) digital signals are generated from a received RF signal. To accomplish this function, the RF signal is received by an antenna 1001 and supplied to a tunable band-pass filter, herein referred to as a tunable pre-selection filter 1003. The tunable pre-selection filter 1003 is capable of tunably selecting channels within the desired frequency band.

From the output of the tunable pre-selection filter 1003, the received signal is supplied to a low noise amplifier 1005. After amplification, the signal is down-converted to respective I and Q baseband signals by first and second mixers 1007, 1009. This is accomplished by mixing the amplified received signal with respective locally-generated signals that each oscillate at (or near) the desired RF frequency, but which are 90 degrees out of phase with respect to one another. As indicated earlier, the purpose of separating the received signal into the I and Q baseband signals is to facilitate the demodulation of the signal (i.e., the extraction of the underlying information carried by the received signal). This aspect of the receiver operation is well-known, and need not be discussed here in further detail.

The respective locally-generated signals for use by the first and second mixers 1007, 1009 are created by first using a local oscillator circuit 1025 to generate a signal of the desired frequency. The local oscillator circuit is preferably implemented as a PLL. This embodiment differs from the previously presented embodiments in that the local oscillator circuit 1025 comprises a VCO 1027 having a tunable resonator (not shown). The tunable resonator of the VCO 1027 is preferably identical to the tunable pre-selection filter 1003. A control signal VTUNE 1033 generated by the local oscillator circuit 1025 is used to bias the tunable resonator of the VCO 1027, thereby causing the local oscillator circuit 1025 to produce a locally generated signal at (or near) the desired RF frequency.

This signal produced by the local oscillator circuit 1025 is supplied to a phase-shifting circuit 1011 that shifts the phase of the locally-generated signal by 90 degrees. The original (non-shifted) signal may then be supplied to the first mixer 1007, while the phase-shifted signal may be supplied to the second mixer 1009.

After down-conversion, the I and Q baseband signals are supplied to respective first and second channel selection filters 1013, 1015. The purpose of the first and second channel selection filters 1013, 1015 is to further separate the received signal from the in-band interferers. In addition, the first and second channel selection filters 1013, 1015 may condition their respective input signals for the purpose of avoiding aliasing that can result from sampling that is performed by downstream analog-to-digital converters. A third possible use of the first and second channel selection filters 1013, 1015 is for channel filtering, although this could alternatively be performed digitally by downstream receiver components.

After channel selection, the resultant I and Q signals could be subjected to further filtering and amplification (e.g., by respective first and second amplifiers 1017, 1019. Because this exemplary embodiment is a digital environment, the resultant analog signals are converted into digital form by respective first and second analog-to-digital (A/D) converters 1021, 1023.

For good performance of the radio receiver, it is necessary to accurately tune the tunable pre-selection filter 1003 so that the desired channel will be selected. To accomplish this function, the control signal VTUNE 1033 generated by the local oscillator circuit 1025 and used to tune the tunable resonator of VCO 1027 is, in accordance with one aspect of the invention, also supplied to a control input of the tunable pre-selection filter 1003. In the case of a homodyne receiver, this arrangement will cause the tunable pre-selection filter 1003 to select (i.e., pass) those components of the received signal having the same frequency as the local oscillator signal. In the case of a low-IF receiver, this arrangement will cause the tunable pre-selection filter 1003 to select (i.e., pass) those components of the received signal having a frequency that is slightly offset from the local oscillator frequency. This offset can be tolerable if the bandwidth of the filter is wide enough.

Because the tunable pre-selection filter 1003 and the tunable resonator of the VCO 1027 are preferably identical to one another, they will be well matched when manufactured on the same IC. Consequently, the control signal 1033 is useful not only for biasing the tunable resonator of the VCO 1027 so that the local oscillator circuit 1025 produces a locally generated signal at (or near) the desired RF frequency, but also for accurately tuning the tunable pre-selection filter 1003. In this respect, the embodiment of FIG. 10 is similar to those embodiments described earlier with reference to FIGS. 3, 4, and 5. The embodiment of

FIG. 10 has additional advantages, however, in that the overall component count for the radio receiver is reduced by eliminating the need for the AM detector and filter controller block components.

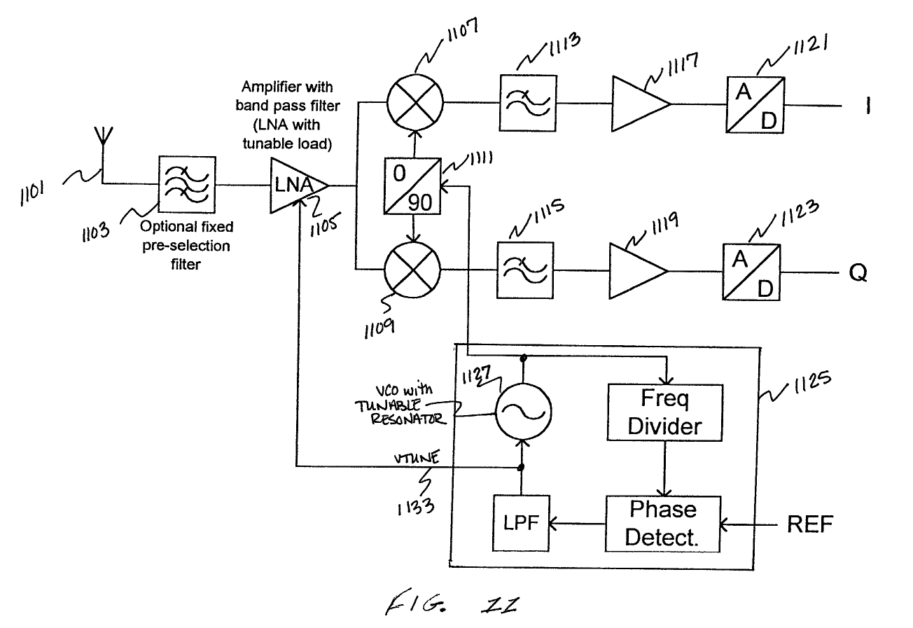

FIG. 11 shows a block diagram of another exemplary embodiment of a receiver in accordance with the invention. The arrangement of FIG. 11 is similar to that of FIG. 10 in that the local oscillator circuits 1025, 1125 in the embodiments each employ a VCO 1027, 1127 having a tunable resonator (not shown). Unlike the receiver of FIG. 10, however, the arrangement of FIG. 11 incorporates the pre-selection filter function performed by the tunable band-pass filter 1003 of FIG. 10 into a low noise amplifier 1105 with a tunable load impedance (not shown). Like the tunable pre-selection filter 1003 of FIG. 10, the low noise amplifier 1105 with a tunable load impedance is capable of tunably selecting channels within the desired frequency band.

As in the earlier presented embodiments, I and Q digital signals are generated from a received RF signal. To accomplish this function, the RF signal is received by an antenna 1101 and then is either supplied to an optional fixed pre-selection band-pass filter 1103 and then to a low noise amplifier 1105 having a tunable load impedance (not shown), or directly to the low noise amplifier 1105. The low noise amplifier 1105 with tunable load impedance operates either as the sole pre-selection filter in the radio receiver, or as an additional pre-selection filter in the receiver, that is capable of tunably selecting channels within the desired frequency band. Inclusion of the optional fixed pre-selection filer 1103 in the signal path eases the design constraints placed on the low noise amplifier 1105, and reduces the overall complexity of the amplifier.

After amplification, the signal is down-converted to respective I and Q baseband signals by first and second mixers 1107, 1109. This is again accomplished by mixing the amplified received signal with respective locally-generated signals that each oscillate at (or near) the desired RF frequency, but which are 90 degrees out of phase with respect to one another. As indicated earlier, the purpose of separating the received signal into the I and Q baseband signals is to facilitate the demodulation of the signal (i.e., the extraction of the underlying information carried by the received signal). This aspect of the receiver operation is well-known, and need not be discussed here in further detail.

The respective locally-generated signals for use by the first and second mixers 1107, 1109 are created by first using a local oscillator circuit 1125 to generate a signal of the desired frequency. The local oscillator circuit is preferably implemented as a PLL. As in the radio receiver depicted in FIG. 10, the local oscillator circuit 1125 comprises a VCO 1127 having a tunable resonator (not shown). The tunable resonator of the VCO 1127 is preferably identical to the tunable load impedance of the low noise amplifier 1105. A control signal VTUNE 1133 generated by the local oscillator circuit 1125 is used to bias the tunable resonator of the VCO 1127, thereby causing the local oscillator circuit 1125 to produce a locally generated signal at (or near) the desired RF frequency.

This signal produced by the local oscillator circuit 1125 is supplied to a phase-shifting circuit 1111 that shifts the phase of the locally-generated signal by 90 degrees. The original (non-shifted) signal may then be supplied to the first mixer 1107, while the phase-shifted signal may be supplied to the second mixer 1109.

After down-conversion, the I and Q baseband signals are supplied to respective first and second channel selection filters 1113, 1115. The purpose of the first and second channel selection filters 1113, 1115 is to further separate the received signal from any in-band interferers that may be present in the baseband signals. In addition, the first and second channel selection filters 1113, 1115 may condition their respective input signals for the purpose of avoiding aliasing that can result from sampling that is performed by downstream analog-to-digital converters. A third possible use of the first and second channel selection filters 1113, 1115 is for channel filtering, although this could alternatively be performed digitally by downstream receiver components.

After channel selection, the resultant I and Q signals could be subjected to further filtering and amplification (e.g., by respective first and second amplifiers 1117, 1119. Because this exemplary embodiment is a digital environment, the resultant analog signals are converted into digital form by respective first and second analog-to-digital (A/D) converters 1121, 1123.

For good performance of the radio receiver, it is necessary to accurately tune the tunable load impedance of the low noise amplifier 1105 so that only those signals with the desired channel will be selected. To accomplish this function, the control signal VTUNE 1133 generated by the local oscillator circuit 1125 and used to tune the tunable resonator of VCO 1127 is, in accordance with one aspect of the invention, also supplied to a control input VTUNE (not shown) of the low noise amplifier 1105. In the case of a homodyne receiver, this arrangement will cause the low noise amplifier 1103 to select (i.e., pass) those amplified components of the received signal having the same frequency as the local oscillator signal. In the case of a low-IF receiver, this arrangement will cause the low noise amplifier 1105 to select (i.e., pass) those amplified components of the received signal having a frequency that is slightly offset from the local oscillator frequency. This offset can be tolerable if the bandwidth of the tunable load impedance is wide enough.

Because the tunable load impedance of the low noise amplifier 1105 and the tunable resonator of the VCO 1127 are preferably identical to one another, they will be well matched when manufactured on the same IC. Consequently, the control signal 1133 is useful not only for biasing the tunable resonator of the VCO 1127 so that the local oscillator circuit 1125 produces a locally generated signal at (or near) the desired RF frequency, but also for accurately tuning the tunable load impedance of the low noise amplifier 1105. In this respect, the embodiment of FIG. 11 is similar to that of FIG. 10. The embodiment of FIG. 11 has the additional advantage, however, in that in addition to eliminating the need for the AM detector and filter controller block components, the complexity and component count of the radio receiver shown in FIG. 11 is further reduced by eliminating the need for a separate tunable pre-selection filter, such as the tunable pre-selection filter 1003 shown in FIG. 10.

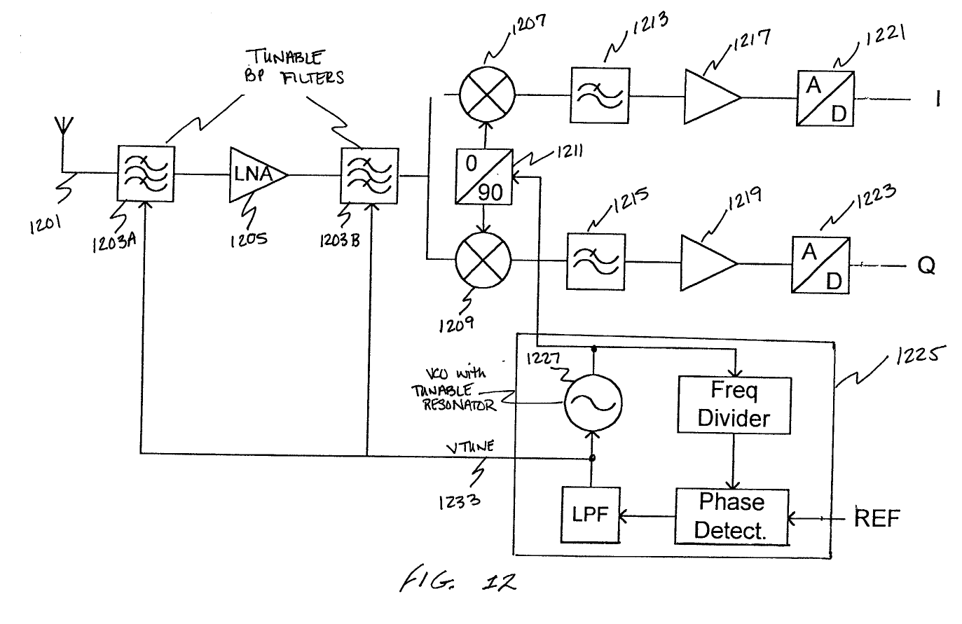

Yet another exemplary embodiment of a single-band direct conversion radio receiver utilizing a VCO having a tuned resonator is shown in FIG. 12. The configuration of this radio receiver is substantially the same as the receiver shown in FIG. 10 with the exception that the tunable pre-selection filter 1003 of FIG. 10 is replaced by two tunable pre-selection filters 1203A, 1203B. As such, with the exception of the operation of these tunable pre-selection filters 1203A, 1203B, the reader is directed to those portions of the written description discussing the radio receiver of FIG. 10, to obtain a detailed description of the function and interaction of those components common to the radio receivers of FIGS. 10 and 12.

To achieve the desired degree of channel selectivity from a pre-selection filter, it is necessary that the filter be designed to have as little loss as possible. Designing these low-loss filters to have the required degree of sensitivity is often difficult to do. To avoid the need for such a low-loss filter, it is preferable to divide the overall filter response among a number of pre-selection filters, each filter in turn requiring a somewhat higher amount loss than would be required of a corresponding single pre-selection filter.

The radio receiver configuration shown in FIG. 12 utilizes this principle by dividing the overall channel selection functionality of tunable pre-selection filter 1003 of FIG. 10 among two tunable pre-selection filters 1203A, 1203B. The first of these tunable pre-selection filters 1203A operates on the RF signal that is received at the antenna 1201. The first tunable pre-selection filter 1203A is capable of tunably selecting channels within the desired frequency band. From the output of the first tunable pre-selection filter 1203A, the received signal is supplied to a low noise amplifier 1205. After amplification, the partially filtered RF signal is supplied to the second tunable pre-selection filter 1203B. The second tunable pre-selection filter 1203B is also capable of tunably selecting channels within the desired frequency band. After channel selection filtering, the signal is down-converted to respective I and Q baseband signals in the same manner as described in conjunction with the radio receiver shown in FIG. 10.

For good performance of the radio receiver, it is necessary to accurately tune the first and second tunable pre-selection filters 1203A, 1203B so that only those signals with the desired channel will be selected. To accomplish this function, the control signal VTUNE 1233 generated by the local oscillator circuit 1225 and used to tune the tunable resonator of VCO 1227 is, in accordance with one aspect of the invention, also supplied to a control input VTUNE (not shown) of each of the first and second tunable pre-selection filters 1203A, 1203B. In the case of a homodyne receiver, this arrangement will cause the first and second pre-selection filters 1203A, 1203B to select (i.e., pass) those components of the received signal having the same frequency as the local oscillator signal. In the case of a low-IF receiver, this arrangement will cause the first and second pre-selection filters 1203A, 1203B to select (i.e., pass) those components of the received signal having a frequency that is slightly offset from the local oscillator frequency. This offset can be tolerable if the bandwidth of the tunable load impedance is wide enough.

It is preferable that first pre-selection filter 1203A, the second pre-selection filter 1203B, and the tunable resonator of the VCO 1227 be identical to one another such that these components will be well matched when manufactured on the same IC. Consequently, the control signal 1233 is useful not only for biasing the tunable resonator of the VCO 1227 so that the local oscillator circuit 1225 produces a locally generated signal at (or near) the desired RF frequency, but also for accurately tuning the first and second tunable pre-selection filters 1203A, 1203B. As with the embodiment shown in FIG. 10, the embodiment of FIG. 12 has the advantage of eliminating the need for the AM detector and filter controller block components required in some of the previously described embodiments. In addition, neither of the tunable pre-selection filters 1203A, 1203B shown in FIG. 12 need be designed to have as low a loss characteristic as is required of the single tunable pre-selection filter 1003 shown in FIG. 10.

The various exemplary embodiments of radio receivers shown in FIGS. 10, 11, and 12 utilizing tuned resonator VCOs and tunable low noise amplifiers have been presented as single-band receivers. It will be understood the concepts described in conjunction with these exemplary embodiments can be applied to produce dual-band direct conversion radio receivers by appropriately adjusting the bandwidths of the tuned resonator VCOs, tunable low noise amplifiers, and tunable pre-selection filters presented in these embodiments.

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

The invention has been described with reference to particular embodiments. However, it will be readily apparent to those skilled in the art that it is possible to embody the invention in specific forms other than those of the preferred embodiment described above. This may be done without departing from the spirit of the invention.

Thus, the exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A radio receiver, comprising:
a front-end circuit that generates a radio frequency (RF) signal, wherein the front-end circuit includes a first tunable band-pass filter that is capable of tunably selecting channels within at least one frequency band;
a local oscillator circuit for generating a local oscillating signal;
a second tunable filter coupled to receive a signal derived from the local oscillating signal and to generate therefrom a filtered local oscillating signal; and
a control unit coupled to receive a signal derived from the filtered local oscillating signal,
wherein:
the control unit generates a control signal based on the signal derived from the filtered local oscillating signal; and
the control signal is supplied to the first tunable band-pass filter and to the second tunable filter for tuning the first tunable band-pass filter and the second tunable filter.

2. The radio receiver of claim 1, further comprising:
an amplitude modulation (AM) detector that receives the filtered local oscillating signal, and generates therefrom the signal derived from the filtered local oscillating signal.

3. The radio receiver of claim 1, wherein the control unit generates the control signal in a manner such that the control signal will cause the signal derived from the filtered local oscillating signal to achieve a maximum value.

4. The radio receiver of claim 1, further comprising:
a mixer for generating a baseband signal by mixing the RF signal with the local oscillating signal.

5. The radio receiver of claim 1, further comprising:
a mixer for generating a baseband signal by mixing the RF signal with the filtered local oscillating signal.

6. The radio receiver of claim 1, wherein each of the first and second tunable band-pass filters is tunable within a range spanning one predefined radio frequency band.

7. The radio receiver of claim 1, wherein each of the first and second tunable band-pass filters is tunable within a range spanning at least two predefined radio frequency bands.

8. The radio receiver of claim 1, further comprising:
a mixer for generating an intermediate frequency (IF) signal by mixing the RF signal with the local oscillating signal.

9. The radio receiver of claim 8, further comprising:
an amplitude modulation (AM) detector that receives the filtered local oscillating signal, and generates therefrom the signal derived from the filtered local oscillating signal.
wherein:
the second tunable filter is a narrow-band filter having a center frequency that is offset with respect to the tunable first band-pass filter; and
the control unit generates the control signal in a manner such that the control signal will cause the signal derived from the filtered local oscillating signal to achieve a maximum value.

10. The radio receiver of claim 8, further comprising:
an amplitude modulation (AM) detector that receives the filtered local oscillating signal, and generates therefrom the signal derived from the filtered local oscillating signal.
wherein:
the second tunable filter is a wide-band filter; and
the control unit generates the control signal by initially adjusting a pass-band of the second tunable filter below a predetermined value, and then adjusting the pass-band of the second tunable filter upward until a signal is detected at the output of the AM detector.

11. The radio receiver of claim 8, further comprising:
an amplitude modulation (AM) detector that receives the filtered local oscillating signal, and generates therefrom the signal derived from the filtered local oscillating signal.
wherein:
the second tunable filter is a wide-band filter; and
the control unit generates the control signal by initially adjusting a pass-band of the second tunable filter above a predetermined value, and then adjusting the pass-band of the second tunable filter downward until a signal is detected at the output of the AM detector.

12. The radio receiver of claim 8, further comprising:
a second mixer for generating a baseband signal by mixing the IF signal with a second local oscillating signal.

13. The radio receiver of claim 8, wherein the IF signal is a first IF signal, and further comprising:
a second mixer for generating a second intermediate frequency signal by mixing the first IF signal with a second local oscillating signal.

14. The radio receiver of claim 1, further comprising:
a mixer for generating an intermediate frequency (IF) signal by mixing the RF signal with the filtered local oscillating signal.

15. The radio receiver of claim 14, further comprising:
a second mixer for generating a baseband signal by mixing the IF signal with a second local oscillating signal.

16. The radio receiver of claim 14, wherein the IF signal is a first IF signal, and further comprising:
a second mixer for generating a second intermediate frequency signal by mixing the first IF signal with a second local oscillating signal.

17. A radio receiver, comprising:
a front-end circuit that generates a radio frequency (RF) signal, the front-end circuit including a first tunable band-pass filter that is capable of tunably selecting channels within at least one frequency band; and
a local oscillator circuit for generating a local oscillating signal and a control signal, the local oscillating circuit including a voltage controlled oscillator having a tunable resonator;
wherein the control signal is supplied to the first tunable band-pass filter and to the tunable resonator for tuning the tunable band-pass filter and the tunable resonator.

18. The radio receiver of claim 17, further comprising:
a mixer for generating a baseband signal by mixing the RF signal with the local oscillating signal.

19. The radio receiver of claim 17, wherein each of the first tunable band-pass filter and the tunable resonator is tunable within a range spanning one predefined radio frequency band.

20. The radio receiver of claim 17, wherein each of the first tunable band-pass filter and the tunable resonator is tunable within a range spanning at least two predefined radio frequency bands.

21. The radio receiver of claim 17, wherein:
the front-end circuit further includes a second tunable band-pass filter that is capable of tunably selecting channels within the at least one frequency band; and
the control signal is further supplied to the second tunable band-pass filter for tuning the second tunable band-pass filter.

22. The radio receiver of claim 21, further comprising:
a mixer for generating a baseband signal by mixing the RF signal with the local oscillating signal.

23. The radio receiver of claim 21, wherein each of the first tunable band-pass filter, the second tunable band-pass filter, and the tunable resonator is tunable within a range spanning one predefined radio frequency band.

24. The radio receiver of claim 21, wherein each of the first tunable band-pass filter, the second tunable band-pass filter, and the tunable resonator is tunable within a range spanning at least two predefined radio frequency bands.

25. A radio receiver, comprising:
a front-end circuit that generates a radio frequency (RF) signal, the front-end circuit including an amplifier having a tunable load that is capable of tunably selecting channels within at least one frequency band; and
a local oscillator circuit for generating a local oscillating signal and a control signal, the local oscillating circuit including a voltage controlled oscillator having a tunable resonator;
wherein the control signal is supplied to the tunable load and to the tunable resonator for tuning the tunable load and the tunable resonator.

26. The radio receiver of claim 25, wherein the front-end circuit further includes a fixed band-pass filter coupled to deliver a filtered RF signal to the amplifier having a tunable load.

27. The radio receiver of claim 25, further comprising:
a mixer for generating a baseband signal by mixing the RF signal with the local oscillating signal.

28. The radio receiver of claim 25, wherein each of the tunable load and the tunable resonator is tunable within a range spanning one predefined radio frequency band.

29. The radio receiver of claim 25, wherein each of the tunable load and the tunable resonator is tunable within a range spanning at least two predefined radio frequency bands.

30. A method of generating a radio frequency signal, comprising the steps of:
receiving a radio frequency (RF) signal;
filtering the received RF signal using a first tunable band-pass filter that is capable of tunably selecting channels within at least one frequency band;
generating a local oscillating signal;
filtering the local oscillating signal using a second tunable filter to produce a filtered local oscillating signal;
generating a control signal based on a signal derived from the filtered local oscillating signal; and
tuning the first tunable band-pass filter and the second tunable filter using the control signal.

31. The method of claim 30, further comprising the step of:
generating the signal derived from the filtered local oscillating signal using an amplitude modulation (AM) detector that receives the filtered local oscillating signal.

32. The method of claim 30, wherein the control signal causes the signal derived from the filtered local oscillating signal to achieve a maximum value.

33. The method of claim 30, further comprising the step of:
generating a baseband signal by mixing the RF signal with the local oscillating signal.

34. The method of claim 30, further comprising the step of:
generating a baseband signal by mixing the RF signal with the filtered local oscillating signal.

35. The method of claim 30, wherein each of the first and second tunable band-pass filters is tunable within a range spanning one predefined radio frequency band.

36. The method of claim 30, wherein each of the first and second tunable band-pass filters is tunable within a range spanning at least two predefined radio frequency bands.

37. The method of claim 30, further comprising the step of:
generating an intermediate frequency (IF) signal by mixing the RF signal with the filtered local oscillating signal.

38. The method of claim 37, further comprising the step of:
generating the signal derived from the filtered local oscillating signal using an amplitude modulation (AM) detector that receives the filtered local oscillating signal;
wherein the second tunable filter is a narrow-band filter having a center frequency that is offset with respect to the tunable first band-pass filter, and the control unit generates the control signal in a manner such that the control signal will cause the signal derived from the filtered local oscillating signal to achieve a maximum value.

39. The method of claim 37, further comprising the step of:
generating the signal derived from the filtered local oscillating signal using an amplitude modulation (AM) detector that receives the filtered local oscillating signal;
wherein the second tunable filter is a wide-band filter, and the control unit generates the control signal by initially adjusting a pass-band of the second tunable filter below a predetermined value, and then adjusting the pass-band of the second tunable filter upward until a signal is detected at the output of the AM detector.

40. The method of claim 37, further comprising the step of:
generating the signal derived from the filtered local oscillating signal using an amplitude modulation (AM) detector that receives the filtered local oscillating signal;
wherein the second tunable filter is a wide-band filter, and the control unit generates the control signal by initially adjusting a pass-band of the second tunable filter above a predetermined value, and then adjusting the pass-band of the second tunable filter downward until a signal is detected at the output of the AM detector.

41. The method of claim 37, further comprising the step of:
generating a baseband signal by mixing the IF signal with a second local oscillating signal.

42. The method of claim 37, wherein the IF signal is a first IF signal, and further comprising the step of:
generating a second IF signal by mixing the first IF signal with a second local oscillating signal.

43. A method of generating a radio frequency signal, comprising the steps of:
receiving a radio frequency (RF) signal;
filtering the received RF signal using a first tunable band-pass filter that is capable of tunably selecting channels within at least one frequency band;
generating a local oscillating signal using a voltage controlled oscillator having a tunable resonator;
generating a control signal based on a signal derived from the local oscillating signal; and
tuning the first tunable band-pass filter and the tunable resonator using the control signal.

44. The method of claim 43, further comprising the steps of:
further filtering the received RF signal using a second tunable band-pass filter that is capable of tunably selecting channels within the at least one frequency band; and
tuning the second tunable band-pass filter using the control signal.

45. A method of generating a radio frequency signal, comprising the steps of:
receiving a radio frequency (RF) signal;
amplifying a portion of the received RF signal using an amplifier having a tunable load that is capable of tunably selecting and amplifying channels within at least one frequency band;
generating a local oscillating signal using a voltage controlled oscillator having a tunable resonator;
generating a control signal based on a signal derived from the local oscillating signal; and
tuning the tunable load and the tunable resonator using the control signal.
